(19) United States
(12) Patent Application Publication
(10) Pub. No.: US 2009/0255980 A1
(43) Pub. Date: Oct. 15, 2009

(54) CONTROL SYSTEMS FOR FRICTION STIR WELDING OF TITANIUM ALLOYS AND OTHER HIGH TEMPERATURE MATERIALS

(75) Inventors: Zhixian LI, Slidell, LA (US); Randy J. Brown, Slidell, LA (US)

Correspondence Address: MCDERMOTT WILL & EMERY LLP, 18191 VON KARMAN AVE., SUITE 500, IRVINE, CA, 92612-7108, US

(73) Assignee: Lockheed Martin Corporation, Bethesda, MD (US)

(21) Appl. No.: 12/198,847

(22) Filed: Aug. 26, 2008

Related U.S. Application Data
(60) Provisional application No. 61/045,224, filed on Apr. 15, 2008.

(51) Int. Cl. B23K 20/12

(52) U.S. Cl. 228/102; 228/2.3

(57) ABSTRACT

Control systems, methods, and algorithms are provided for controlling the process parameters during FSW in order to repeatedly produce high quality welds for high temperature alloys such as titanium alloys and superalloys. In accordance with exemplary embodiments of the present invention, a desired range of forge load, pinch load, and/or travel load can be reliably maintained in a FSW system by adjusting the rotational speed thereof. In other embodiments, a desired temperature range of the tool or weld can be maintained by adjusting a plunge depth of pin tool for conventional FSW or distances between upper and lower shoulders for self-reacting FSW processes. Other embodiments of the present invention provide methods and/or apparatus suitable for rotational control and/or plunge depth control for FSW of titanium alloys and/or other high temperature alloys such as super alloys.

### RELATED APPLICATION

This application claims priority to U.S. Provisional Patent Application No. 61/045,224 filed 15 Apr. 2008, the entire contents of which are incorporated herein by reference.

### STATEMENT REGARDING FEDERALLY SPONSORED RESEARCH OR DEVELOPMENT

Not Applicable

### FIELD OF THE INVENTION

The present invention generally relates to friction stir welding/processing and, in particular, relates to control systems and methods for friction stir welding of titanium alloys and other high temperature alloys.

### BACKGROUND OF THE INVENTION

In friction stir welding (“FSW”), a cylindrical-shouldered tool, with a profiled probe (also known as a nib or a pin) is rotated at a constant speed and fed at a constant traverse rate into the joint line between two pieces of sheet or plate material, which are butted together. Examples of previous FSW techniques are described in U.S. Pat. No. 5,460,317, the entire contents of which are incorporated herein by reference.

FIG. 1 depicts a diagrammatic perspective view of a prior art FSW process. In the example shown in FIG. 1, a pair of plates 1A, 1B (e.g., aluminum alloy) are butted together about a joint line 2. A non-consumable probe 3 of steel having a narrow central, cylindrical portion 4 (or “pin”) positioned below an upper sections 5, which is held by a tool holder or spindle 7, is brought to the edge of the joint line 2 between the plates 1A, 1B. The probe 3 is rotated by a motor connected to the spindle 7 while the probe 3 is traversed in a direction 8 and while the plates are held against lateral movement away from the probe 3. The rotating probe 3 produces a local region of highly plasticized material around the steel pin portion 4.

In FSW, the length of the pin is typically slightly less than the weld depth required and the tool shoulder (shown as bottom face of 5, facing the work pieces) is in intimate contact with the work surface. Frictional heat is generated between the wear-resistant welding tool shoulder and nib, and the material of the work pieces. This heat, along with the heat generated by the mechanical mixing process and the adiabatic heat within the material, causes the stirred materials to soften without melting, allowing the traversing of the tool along the weld line in a plasticized tubular shaft or region of metal. As the pin is moved in the direction of welding, the leading face of the pin, assisted by a special pin profile, forces plasticized material to the back of the pin while applying a substantial forging force to consolidate the weld metal.

During the typical FSW process, both displacement control and load control may be used to ensure a good weld. Displacement control is a technique by which the displacement of the tool (e.g., as shown by ΔD in FIG. 1), including shoulder and pin, relative to the metal pieces to be welded, e.g., the metal surfaces on the back anvil or work surface. Load control is a technique by which the contact force between the tool and the metals (e.g., as shown by F with corresponding reactive force, F′, in FIG. 1) is maintained at a constant value or within a specified load range. Examples of load control FSW techniques are described in U.S. Pat. No. 6,421,578, assigned to the assignee of the present disclosure, and the entire contents of which are incorporated herein by reference.

Using displacement control techniques has drawbacks as both workpiece thickness and the setup of the FSW machine must be tightly controlled to make good welds. Accordingly, load control is widely used for the FSW process, as it works very well to produce high quality welds during FSW of materials such as aluminum and copper alloys. Load control is based on the premise that forge load will decrease if plunge depth is decreased, and vice versa. Therefore, a good quality weld is obtained via adjusting the plunge depth to maintain a desired forge load value during the FSW process. For aluminum and copper alloys, the response of forge load to plunge depth operates as aforementioned, and load control accordingly works well for these alloys. Force control techniques for FSW of metal matrix composites, ferrous alloys, non-ferrous alloys, and superalloys and temperature control techniques to increase tool life are described in U.S. Patent Application Publication No. US 2005/0051602, the entire contents of which are incorporated herein by reference.

Load control techniques, however, do not work well for certain high temperature alloys, such as titanium alloys, due to the complex response (e.g., nonlinear) of such alloys to plunge depth of the pin tool. Accordingly, a different approach to controlling the FSW is needed for high temperature alloys such as titanium alloys.

### SUMMARY OF THE INVENTION

According to an aspect of the present invention, control systems and methods are provided for controlling the process parameters during FSW in order to repeatedly produce high quality welds for high temperature alloys such as titanium alloys. In accordance with exemplary embodiments of the present invention, a desired range of forge load and/or travel load can be reliably maintained in a FSW system by adjusting the rotational speed thereof. In other embodiments, a desired temperature range of the tool or weld can be maintained by adjusting a plunge depth of a FSW system during a FSW process. Other embodiments of the present invention provide methods and/or apparatus suitable for rotational control and/or plunge depth control of FSW for titanium alloys and/or other high temperature alloys, e.g., so-called super alloys.

It is to be understood that both the foregoing summary of the invention and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 depicts an arrangement of a prior art FSW forge-load control and displacement control configuration;

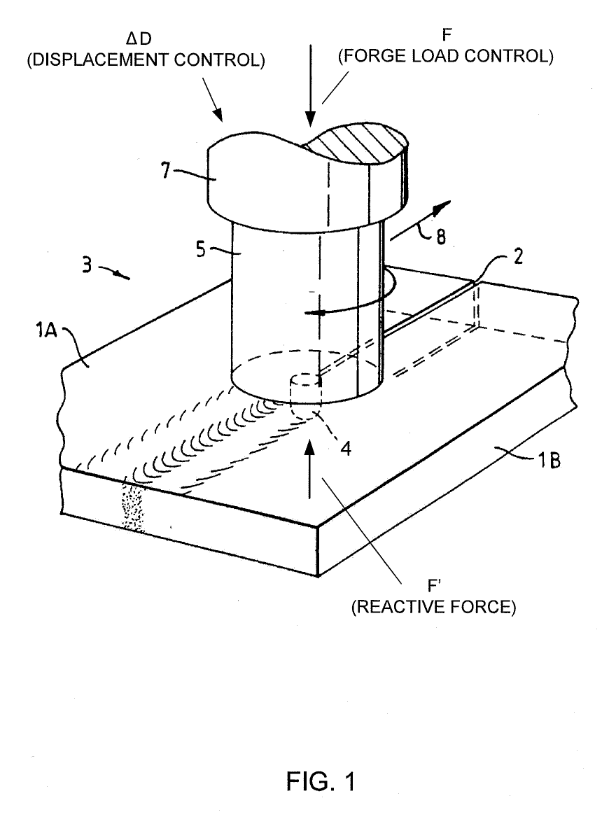

FIG. 2 is a plot of experimental data acquired during FSW of a Ti alloy in accordance with one aspect of the present invention;

FIG. 3 is a plot illustrating a response of forge load to rotational speed during FSW of a Ti alloy in accordance with one embodiment of the present invention;

FIG. 4 is a flow chart illustrating a logic algorithm for implementing a FSW method in accordance with one embodiment of the present invention; and

FIG. 5 is a flow chart illustrating a logic algorithm for implementing a FSW method in accordance with one embodiment of the present invention.

FIG. 6 depicts a diagrammatic view of a system in accordance with an exemplary embodiment of the present invention; and

FIG. 7 depicts a diagrammatic view of a method in accordance with an exemplary embodiment of the present invention.

While certain figures are shown, one skilled in the art will appreciate that the embodiments depicted in the drawings are illustrative and that variations of those shown, as well as other embodiments described herein, may be envisioned and practiced within the scope of the present disclosure.

### DETAILED DESCRIPTION OF THE INVENTION

The present disclosure is directed to control systems, methods, and control algorithms for controlling the process parameters during FSW in order to repeatedly produce high quality welds for high temperature alloys such as titanium alloys. Other high temperature alloys that may be welded by the FSW techniques described herein can include, but are not limited to, various of the steels, iron-based, nickel-based, chromium-based alloys, etc. including the so-called super alloys. Examples of superalloys include Hastelloy, Inconel, Waspaloy, Rene alloys (e.g., Rene 41, Rene 80, Rene 95), Haynes alloys, Incoloy, MP98T, TMS alloys, and CMSX single crystal alloys, among others.

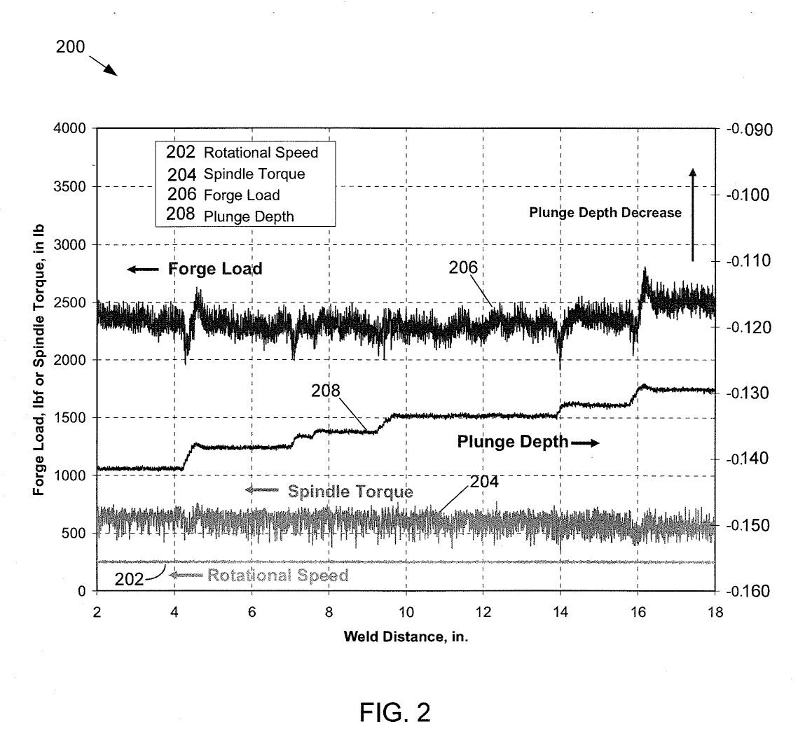

For many high temperature alloys/materials, e.g., Ti alloys, forge load during FSW has a complex response to plunge depth. Consequently, neither load control nor displacement control is sufficient to make consistently high quality friction stir welds. This can be seen from FIG. 2, which is a plot 200 of data including rotational speed 202, spindle torque 204, forge load 206, and plunge depth 208 acquired by the present inventors during FSW of a Ti-6Al-4V alloy in accordance with one aspect of the present invention. It can be seen in FIG. 2 that the forge load remained about the same or even increased when plunge depth was decreased. Thus, it is clear that the load control method does not work as expected with this alloy, as the forge load is either insensitive to or has a reverse response to plunge depth. In other words, maintaining a certain forge load (force) or pin tool displacement does not work as a method to ensure high quality friction stir welds for titanium and titanium alloys.

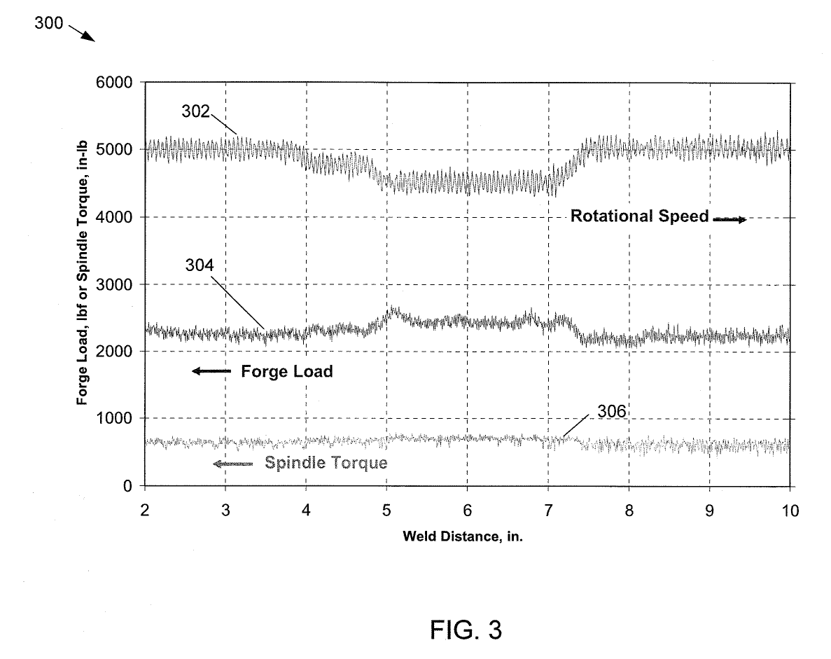

In accordance with one aspect of the present invention, a desired range of forge load and/or travel load, where travel load is the load that pin tool experiences in the travel direction during FSW, can be reliably maintained by adjusting the rotational speed during FSW of high temperature alloys, e.g., a Ti-6Al-4V alloy. The present inventors have conducted extensive welding data collection and verified that maintaining a desired range of forge load and/or travel load can consistently produce high quality FSW welds, as is illustrated in FIG. 3, which depicts a plot 300 of rotational speed 302 (e.g., in rpm), forge load 304, and spindle torque 306 along weld distance (in inches).

As can be seen from FIG. 3, forge load 304 was maintained at a stable value range of 2200 lbs when the rotational speed was at 250 rpm. The forge load was increased to ˜2500 lbs range when the rotational speed 302 was decreased to 200 rpm. The forge load 304 was reduced back to ˜2200 lbs range again when the rotational speed was increased back to 250 rpm.

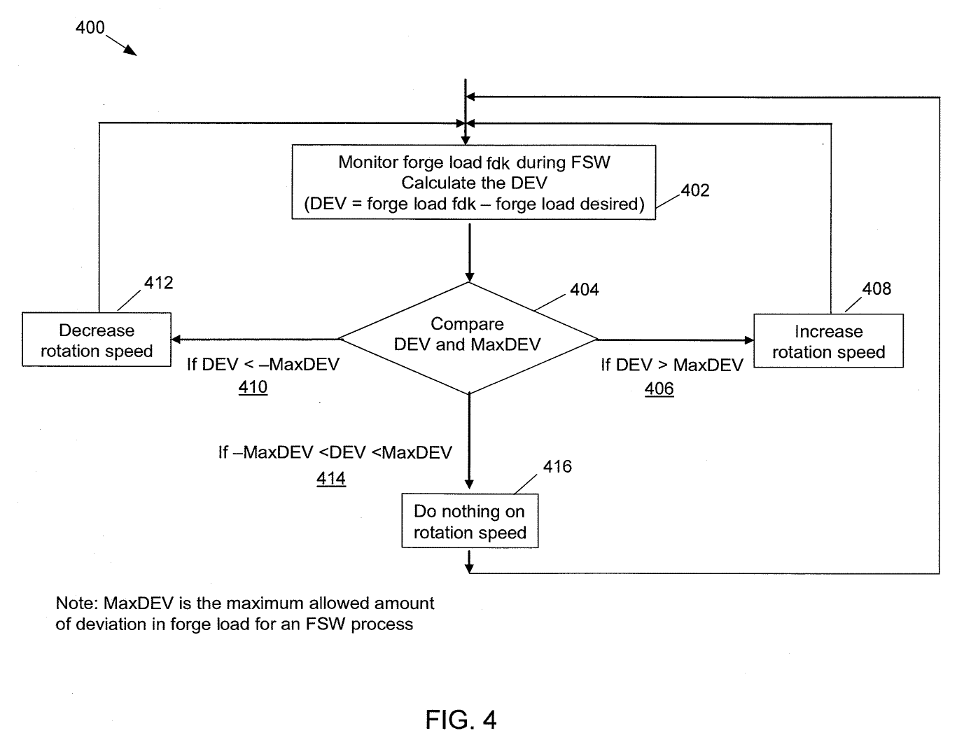

In accordance with one aspect of the present invention, a FSW control system and/or method, referred to hereinafter as the load-spindle control, can maintain a desired range of forge load and/or travel load by adjusting the rotational speed of the spindle and tool of a FSW system, e.g., FSW mill with driven spindle and pin tool. A flow chart illustrating the logic algorithm for implementing an embodiment of such a method is illustrated in FIG. 4.

As depicted in FIG. 4, algorithm 400 can include monitoring forge load feedback during FSW and calculating the deviation (DEV), where the deviation equals the forge load indicated by the forge load feedback minus the desired forge load, as described at 402. Continuing with the description of algorithm 400, a comparison can be made between DEV and MaxDEV, where MaxDEV is the maximum allowed amount of deviation in forge load for a FSW process, as described at 404.

For the condition where DEV>MaxDEV (as indicated at 406), the rotation speed of the pin tool can be increased, e.g., by providing a command to a FSW controller to increase rotation speed of the related pin tool and spindle, as described at 408. For the condition where DEV←MaxDEV (as indicated at 410), the rotation speed of the pin tool can be decreased, e.g., by providing a command to a FSW controller to decrease rotation speed of the related pin tool and controller, as described at 412. For the condition where—MaxDEV<DEV<MaxDEV (as indicated at 414), the rotation speed of the pin tool can be left as is, e.g., by providing a maintenance or no command to a FSW controller so that rotation speed of the related pin tool and spindle is not adjusted or left alone, as described at 416

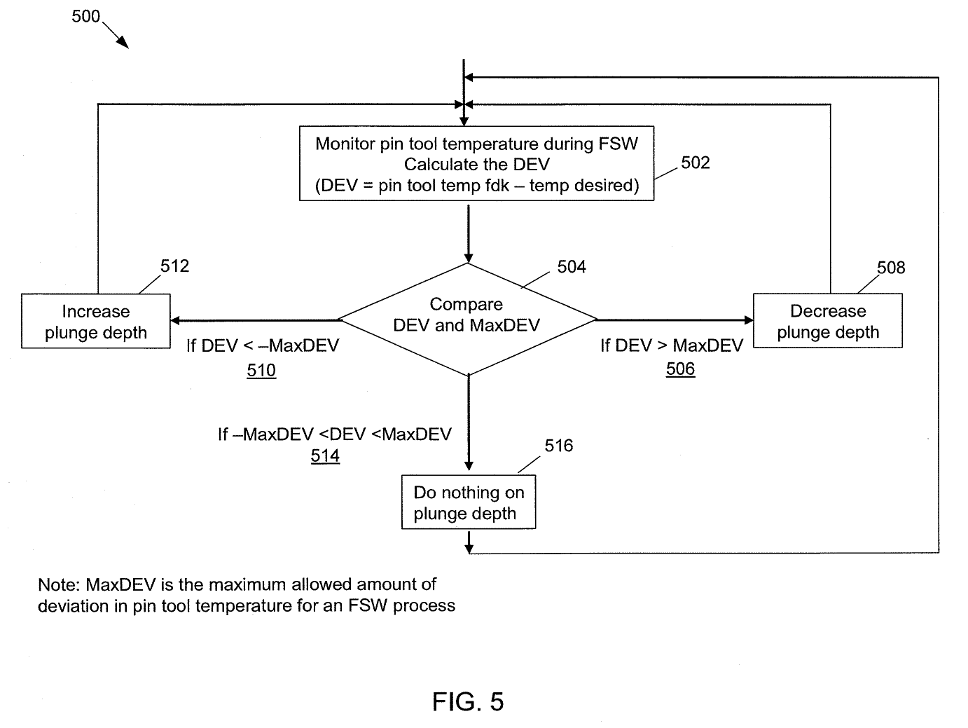

According to one aspect of the present invention, a load-spindle control system, e.g., as shown and described for FIG. 5, can utilize real time data acquisition on forge load and/or travel load. There is no technical challenge in real time data acquisition/monitoring, as conventional technology can be utilized to accomplish this task. As described previously, forge load is sensitive to rotational speed and can be controlled reliably via adjusting rotational speed. Travel load can also be controlled by adjusting rotational speed in order to consistently obtain high quality welds, as there is a desired travel load range that is a reliable indication of producing good welds during FSW.

According to another aspect, maintaining the pin tool or weld (or portion of the weld region) at a desired temperature range can ensure consistent production of high quality welds during FSW for all materials that are friction stir weldable including alloys of Al, Cu, and high-temperature alloys such as those of Ti, Ni, and steels. Controlling a desired temperature range on pin tool (or weld) can be reliably achieved via adjusting plunge depth during FSW. This control method will be referred as temperature-position control system. Quality FSW welds may also be achieved in steels, Ni based superalloys and other alloys by such techniques. A logic algorithm for this method is illustrated in FIG. 5, in accordance with one embodiment of the present invention.

As depicted in FIG. 5, algorithm 500 can include monitoring pin tool temperature or temperature of the weld near the pin tool during FSW and calculating the deviation (DEV), where the deviation equals the pin tool temperature indicated by the pin tool or weld temperature feedback minus the desired pin tool temperature, as described at 502. Continuing with the description of algorithm 500, a comparison can be made between DEV and MaxDEV, where MaxDEV is the maximum allowed amount of deviation in pin tool temperature for a FSW process, as described at 504.

For the condition where DEV>MaxDEV (as indicated at 506), the plunge depth of the pin tool can be decreased, e.g., by providing a command to a FSW controller to decrease the plunge depth of the related pin tool and spindle, as described at 508. For the condition where DEV←MaxDEV (as indicated at 510), the plunge depth of the pin tool can be increased, e.g., by providing a command to a FSW controller to increase plunge depth of the related pin tool and controller, as described at 512. As shown in FIG. 5, for the condition where—MaxDEV<DEV<MaxDEV (as indicated at 514), the plunge depth of the pin tool can be left as is or alone, e.g., by providing a maintenance or no command to a FSW controller so that plunge depth of the related pin tool is not adjusted, as described at 516.

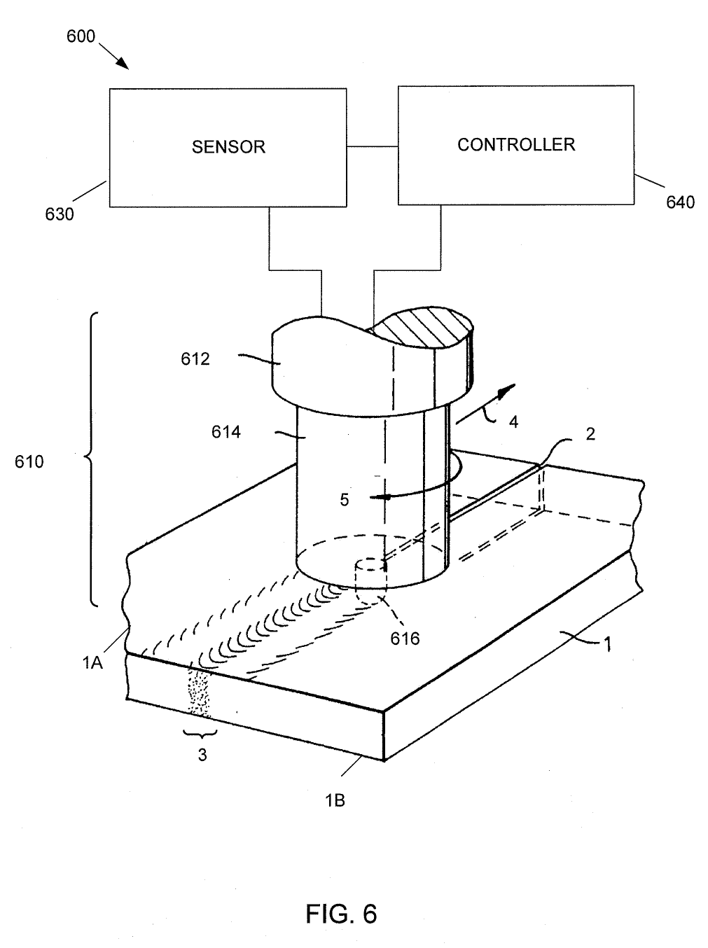

FIG. 6 depicts a diagrammatic view of an embodiment of a system 600 in accordance with the present disclosure. System 600 can include a FSW mill 610 (though only a portion including tool holder/spindle and pin tool is shown). The spindle or tool holder 612 of the FSW mill 610 and tool 614 are connected to pin 616 as shown. Work pieces 1A and 1B (referenced by 1 when welded) to be welded are shown pressed together along abutment line 2, with the weld indicated by 3. The travel of the FSW mill relative to the work piece is shown by 4 and the rotation of the spindle and pin tool 616 is shown by 5.

One or more sensors can be included for a sensor system 630 The sensors are configured and arranged to detect or sense an operational parameter or physical parameter of the FSW process, e.g., rotational speed of spindle (and, therefore, pin tool), forge load, travel load, temperature or pin tool or weld, and/or plunge depth.

In exemplary embodiments, the one or more sensors can include one or more temperature sensors that are configured and arranged to detect the temperature of the pin tool and/or weld region during a FSW process. Suitable temperature sensors can include, but are not limited to, a thermocouple connected to the pin tool. In exemplary embodiments, a radio collar can be connected to the spindle and electrically connected to the thermocouple and configured and arranged to transmit a temperature signal indicating the temperature detected by the thermocouple. In other embodiments, the one or more temperature sensors can include an infrared detector (or detector array) configured and arranged to detect a desired range of infrared wavelengths. Such infrared detectors can include suitable desired optics. Other embodiments can utilize one or more load sensors to detect forge and/or travel load during the FSW process.

With continued reference to FIG. 6, a controller 640 is connected to the sensors system 630 and operates to control a desired operational parameter of the FSW system including FSW mill 610. For example, for load-spindle control embodiments, the controller 640 can operate to maintain a desired range of forge load and/or travel load by way of controlling the rotational speed of the spindle and pin during a FSW process. In such embodiments (which may be referred to as load-spindle control embodiments), controller 640 can operate to implement a suitable control algorithm, e.g., one including or consisting of algorithm 400 shown and described for FIG. 4.

Controller 640 may also or in the alternative operate to maintain or control operation within a desired temperature range on the pin tool or weld by way of controlling the plunge depth during a FSW process. In such embodiments, (which may be referred to as temperature-position control embodiments), controller 640 can operate to implement a suitable control algorithm, e.g., one including or consisting of algorithm 500 shown and described for FIG. 5.

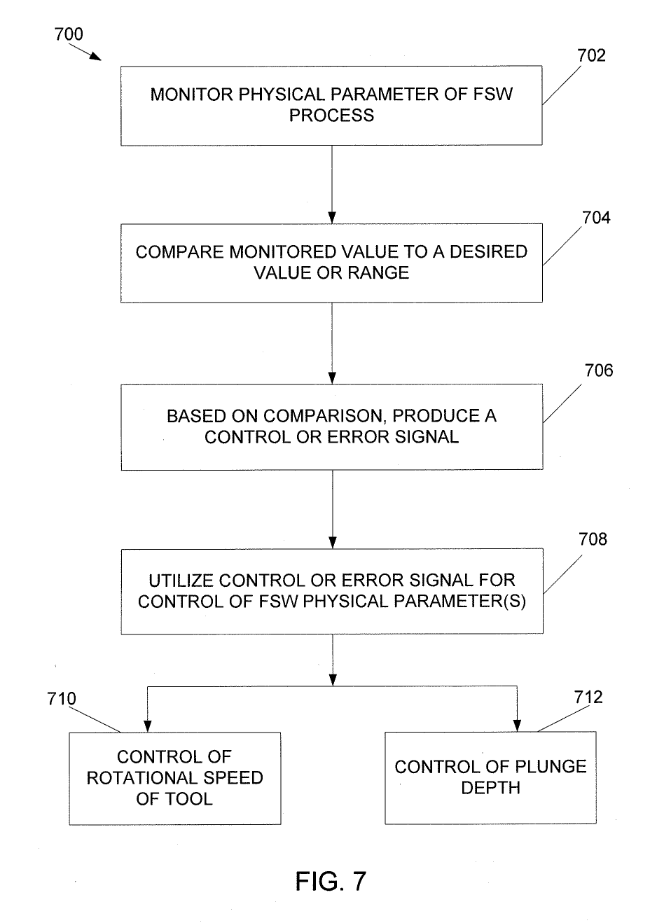

FIG. 7 depicts an embodiment of a method 700 in accordance with the present disclosure. One or more physical parameters of a FSW process can be monitored, as described at 702. Such monitoring can be accomplished with one or more sensors, e.g., as described for system 600 of FIG. 6. The monitored or sensed value(s) of the FSW physical parameter(s) can be compared to a desired value or range for the physical parameter(s), as described at 704. Such desired value(s) or range(s) can be, for example, stored or input to a controller connected to the related FSW system, e.g., as shown and described for FIG. 6. Based on the comparison, a control signal (e.g., an error signal) can be produced or determined, as described at 706.

Continuing with the description of method 700, the control signal (error signal) can be utilized to control one or more FSW parameters, as described at 708. An example can include control or adjustment rotation speed of the spindle and pin tool based on deviation of sensed forge load from a desired forge load reading or range, as described at 710. A further example can include control or adjustment plunge depth of the pin tool based on a sensed temperature of the pin tool and/or weld region, as described at 712.

The descriptions herein of embodiments of the present invention are provided to enable any person skilled in the art to practice the various embodiments described herein and obvious variations thereof. While the present invention has been particularly described with reference to the various figures and embodiments, it should be understood that these are for illustration purposes only and should not be taken as limiting the scope of the invention.

There may be many other ways to implement the present invention. Various functions and elements described herein may be partitioned differently from those shown without departing from the spirit and scope of the invention. Embodiments of the present invention may also be implanted with so-called self-reacting FSW in which a pin tool extends through the workpiece(s) and attached to a lower shoulder. For such, the load-spindle control and temperature-position control can be applied to a self-reacting process, with pinch load parameters/measurements replacing forge load and plunge depth being replaced by the distance between the upper shoulder and lower shoulder. Moreover, embodiments described herein are not limited to FSW but may also implemented for thermal stir welding (“TSW”) techniques in which heat sources are utilized to heat the workpieces instead of relying upon only the frictional heat provided by the rotating spindle and pin tool. In TSW techniques, two stationary shoulders can be utilized (upper and lower shoulders) with a rotating pin.

Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the invention.

A reference to an element in the singular is not intended to mean “one and only one” unless specifically stated, but rather “one or more.” The term “some” refers to one or more. Underlined and/or italicized headings and subheadings are used for convenience only, do not limit the invention, and are not referred to in connection with the interpretation of the description of the invention. All structural and functional equivalents to the elements of the various embodiments described throughout this disclosure that are known or later come to be known to those of ordinary skill in the art are expressly incorporated herein by reference and intended to be encompassed by the invention. Moreover, nothing disclosed herein is intended to be dedicated to the public regardless of whether such disclosure is explicitly recited in the above description.

What is claimed is:

1. A friction stir welding system comprising:
a FSW mill including a pin tool;
a sensor system including one or more sensors configured and arranged to detect physical parameters of a FSW process performed by the FSW mill; and
a controller connected to the sensor system and the FSW mill, wherein the controller is configured and arranged to control one or more operational parameters of the FSW mill during the FSW process.

2. The system of claim 1, wherein the sensor system comprises one or more temperature sensors configured and arranged to detect a temperature of the pin tool or the weld region.

3. The system of claim 2, wherein the controller is configured and arranged to compare a detected temperature to a desired temperature or temperature range.

4. The system of claim 3, wherein the controller is configured and arranged to provide a control signal to the FSW mill to adjust the plunge depth of the pin tool of the FSW mill.

5. The system of claim 1, wherein the sensor system comprises one or more load sensors configured and arranged to detect a forge and/or travel load during a FSW process.

6. The system of claim 5, wherein the controller is configured and arranged to compare a detected load value to a desired load or load range.

7. The system of claim 6, wherein the controller is configured and arranged to provide a control signal to the FSW mill to adjust the spindle rotation speed of the pin tool of the FSW mill.

8. The system of claim 2, wherein the one or more temperature sensors comprise a thermocouple connected to the pin tool.

9. The system of claim 8, further comprising a radio collar connected to the spindle and electrically connected to the thermocouple and configured and arranged to transmit a temperature signal indicating the temperature detected by the thermocouple.

10. The system of claim 2, wherein the one or more temperature sensors comprise an infrared detector configured and arranged to detect a desired range of infrared wavelengths.

11. A FSW control method comprising:
monitoring a physical parameter of a FSW process;
comparing a detected value of the physical parameter to a desired value or range and effecting a comparison;
producing a control signal based on the comparison; and
controlling an operational parameter of the FSW process by the control signal.

12. The method of claim 11, wherein the physical parameter of the FSW process is temperature of the pin tool.

13. The method of claim 11, wherein the physical parameter of the FSW process is temperature of the weld produced during the FSW process.

14. The method of claim 11, wherein the physical parameter of the FSW process is forge load.

15. The method of claim 11, wherein the physical parameter of the FSW process is pinch load for self-reacting FSW.

16. The method of claim 11, wherein the physical parameter of the FSW process is travel load.

17. The method of claim 12, wherein the operational parameter of the FSW process is plunge depth of the pin tool.

18. The method of claim 12, wherein the operational parameter of the FSW process is the distance between the upper and lower shoulders for self-reacting FSW.

19. The method of claim 13, wherein the operational parameter of the FSW process is plunge depth of the pin tool.

20. The method of claim 14, wherein the operational parameter of the FSW process is rotation speed of the FSW spindle.

21. The method of claim 15, wherein the operational parameter of the FSW process is rotation speed of the FSW spindle.

22. The method of claim 11, wherein the FSW process includes FSW of one or more high-temperature alloys.

23. The method of claim 22, wherein the FSW process includes FSW of a titanium alloy.

24. The method of claim 23, wherein the titanium alloy comprises Ti-6AL-V4

25. The method of claim 22, wherein the one or more high-temperature alloys comprise a superalloy.
